(19) United States
(12) Patent Application Publication
(10) Pub. No.: US 2024/0145755 A1
(43) Pub. Date: May 2, 2024

(54) Central Tube Assembly for Battery, Battery, and Manufacturing Method of Central Tube Assembly for Battery

(71) Applicants: Microvast Power Systems Co., Ltd., Huzhou (CN); Microvast, Inc., Stafford, TX (US)

(72) Inventors: Yang WU, Honolulu, HI (US); Guoyou DENG, Huzhou (CN); Xiaofeng YIN, Huzhou (CN); Xiaojie SHEN, Huzhou (CN); Yu YAO, Huzhou (CN)

(21) Appl. No.: 18/383,915

(22) Filed: Oct. 26, 2023

Related U.S. Application Data
(60) Provisional application No. 63/420,143, filed on Oct. 28, 2022.

(51) Int. Cl. H01M 10/04

(52) U.S. Cl. CPC H01M 10/0431

(57) ABSTRACT

A central tube assembly for a battery, a battery, and a manufacturing method of a central tube assembly for a battery is provided. The central tube assembly for a battery comprises: a central tube and at least one battery center pin; the battery center pins are provided on the outer periphery of the central tube, each battery center pin is sleeved on the central tube to form the central tube assembly, and the battery center pins are electrically insulated from the central tube. The central tube assembly for a battery of the present disclosure overcomes the situation in the related art that the central tube is separated from the battery center pins, reduces a welding process during battery manufacturing, and greatly enhances the sealing performance of the battery.

### CROSS-REFERENCE TO RELATED APPLICATION(S)

The present disclosure claims priority to Application No. 63/420,143, filed to the United States Patent and Trademark Office on Oct. 28, 2022.

### TECHNICAL FIELD

The present disclosure relates to the field of batteries, and in particular, to a central tube assembly for a battery, a battery, and a manufacturing method for a central tube assembly for a battery.

### BACKGROUND

In a battery, a battery central tube plays roles of supporting, protecting a winding core and cooling. In a related art, the battery central tube is generally separated from battery center pins, through other structural parts of the battery which is in combination with the central tube and the battery center pins, etc., the battery is finally manufactured. The manufacturing process increases a welding process during battery manufacturing, and reduces the sealing performance of the battery.

### SUMMARY

A main object of the present disclosure is to provide a central tube assembly for a battery, a battery, and a manufacturing method of a central tube assembly for a battery, so as to solve the issue in the related art that battery center pins are separated from a central tube, and to reduce a welding process during battery manufacturing.

According to one aspect of the present disclosure, provided is a central tube assembly for a battery, including: a central tube; and at least one battery center pin, arranged on an outer periphery of the central tube, each battery center pin being sleeved on the central tube to form the central tube assembly, and the each battery center pin being electrically insulated from the central tube.

As some implementations, the central tube assembly for the battery further includes a first insulation member, wherein the first insulation member is located between an outer surface of the central tube and an inner surface of the at least one battery center pin.

As some implementations, at least one first insulation member is formed between the central tube and the at least one battery center pin by injection molding.

As some implementations, the central tube assembly for the battery further includes at least one support member provided on the central tube, wherein each support member is used for supporting a corresponding battery center pin.

As some implementations, the central tube assembly for the battery includes two battery center pins and two support members, and a bottom end of each battery center pin is provided with the support member.

As some implementations, the central tube assembly for the battery further includes a second insulation member, wherein the second insulation member is arranged on an outer periphery of the support member.

As some implementations, the second insulation member is sleeved on the outer periphery of the each support member.

As some implementations, the second insulation member includes a first cylindrical section and a second cylindrical section connected to each other; an outer diameter of the first cylindrical section is smaller than an outer diameter of the second cylindrical section, the first cylindrical section has a first mounting hole, the second cylindrical section has a second mounting hole in communication with the first mounting hole, and the each support member is located in the second mounting hole; the first cylindrical section is located between the battery center pin and the central tube, and a step surface capable of supporting the battery center pin is formed between an outer wall surface of the first cylindrical section and an outer wall surface of the second cylindrical section.

As some implementations, an end of each battery center pin is provided with an annular flange.

As some implementations, the central tube assembly for the battery further includes: a third insulation member, arranged on an outer periphery of the each battery center pin, wherein the annular flange is used to support the third insulation member, and the third insulation member is configured to be fixedly connected to a cover plate.

As some implementations, a distance between an upper end face of the battery center pin located above the central tube and an upper end face of the central tube is 1/10 to ⅖ of the length of the central tube, and/or a distance between a lower end face of the battery center pin located below the central tube and a lower end face of the central tube is 1/10 to ⅖ of the length of the central tube.

As some implementations, a distance between an upper end face of the battery center pin located above the central tube and an upper end face of the central tube is 5 mm-40 mm, and/or a distance between a lower end face of the battery center pin located below the central tube and a lower end face of the central tube is 5 mm-40 mm.

As some implementations, a radial distance between the each battery center pin and the central tube is 0.5 mm-10 mm, and the radial distance is used for providing the first insulation member.

According to another aspect of some embodiments of the present disclosure, provided is a battery, including a housing and the described central tube assembly for the battery provided in the housing.

As some implementations, the battery further includes a cell wound around the outer periphery of the central tube and an electrical connection member, wherein one end of the electrical connection member is electrically connected with the battery center pin, and the other end of the electrical connection member is electrically connected with a tab of the cell.

According to another aspect of some implementations of the present disclosure, provided is a manufacturing method of a central tube assembly for a battery, the manufacturing method is used for manufacturing the described central tube assembly for the battery, and the manufacturing method includes: sleeving the at least one battery center pin on an outer surface of the central tube to form the central tube assembly.

As some implementations, the manufacturing method further includes: reserving a radial distance d of 0.5 mm-10 mm between the at least one battery center pin and the central tube, and performing injection molding processing between the at least one battery center pin and the central tube to form at least one first insulation member.

As some implementations, the manufacturing method further includes: providing support members on the outer periphery of the central tube; and sleeving second insulation members on the outer periphery of the support members, and sleeving the battery center pins on a part of the outer periphery of the second insulation members.

As some implementations, the manufacturing method further includes: forming a third insulation member on an outer periphery of the at least one battery center pin by injection molding.

By applying the technical solutions of some embodiments of the present disclosure, the battery center pins are sleeved on the outer surface of the central tube, and the battery center pins are integrated on the central tube, thereby overcoming the issue in the related art that the central tube is separated from the battery center pins, reducing a welding process during battery manufacturing, and greatly enhancing the sealing performance of the battery.

### BRIEF DESCRIPTION OF THE DRAWINGS

The drawings of the description, constituting a part of some embodiments of the present disclosure, are used for providing further understanding of some embodiments of the present disclosure, and the illustrative embodiments of the present disclosure and illustrations thereof are used to explain some embodiments of the present disclosure, rather than constitute inappropriate limitation on some embodiments of the present disclosure. In the drawings:

FIG. 1 shows a schematic diagram of a three-dimensional structure of embodiments of a central tube assembly for a battery according to the present disclosure;

FIG. 2 shows a cross-sectional view along an A-A direction of the central tube assembly for the battery as shown in FIG. 1;

FIG. 3 shows a schematic structural diagram of embodiments of a battery according to the present disclosure;

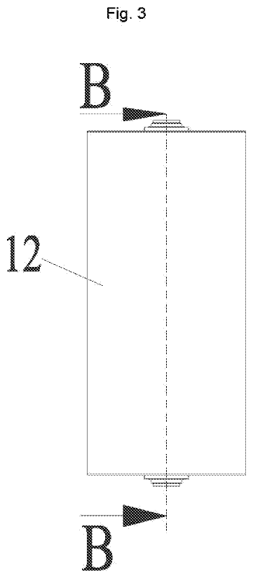

FIG. 4 shows a perspective view in a B-B direction of the battery of FIG. 3;

FIG. 5 shows a cross-sectional view of another embodiments of the battery of FIG. 3; and

FIG. 6 shows a cross-sectional view of another embodiments of the battery of FIG. 3.

The figures include the following reference signs:
1. Central tube; 2. Battery center pin; 2-1. Annular flange; 3. Support member; 4. First insulation member; 5. Second insulation member; 5-1. First cylindrical section; 5-2. Second cylindrical section; 5-3. Step surface; 6. Third insulation member; 7. Cover plate; 7-1. First metal connection member; 7-2. Second metal connection member; 7-3. First cover plate insulation member; 7-4. Second cover plate insulation member; 8. Electrical connection member; 9. Housing.

### DETAILED DESCRIPTION OF THE EMBODIMENTS

It should be noted that the embodiments in the present disclosure and features in the embodiments can be combined with each other without conflicts. Hereinafter, the present disclosure will be described in detail with reference to the drawings in combination with embodiments. Obviously, the embodiments as described are only some of the embodiments of the present disclosure, rather than all the embodiments. All other embodiments obtained by a person of ordinary skill in the art on the basis of the illustration of the present disclosure without any inventive effort shall all fall within the scope of protection of the present disclosure.

In the illustration of the present disclosure, unless otherwise explicitly specified and limited, terms “provide”, “mount” and “connect”, etc. should be understood broadly, and for example, may be fixed connection, and may also be detachable connection, or integral connection; may be mechanical connection, and may also be electrical connection; and may be direct connection, and may also be indirect connection by means of an intermediate medium. For a person of ordinary skill in the art, the specific meanings of the described terms could be understood according to specific situations.

Orientation or positional relationships indicated by terms such as “upper”, “lower”, “left”, “right”, “front”, “rear”, “top”, “bottom”, “inner”, and “outer”, etc. are orientation or positional relationships based on those as shown in the drawings, or based on orientation or positional relationships of a product of the present disclosure which is conventionally placed during use, and are only used to facilitate the illustration and to simplify the illustration, rather than indicating or implying that an apparatus or element referred to must have a specific orientation, and be constructed and operated in the specific orientation, and therefore said terms cannot be understood as limiting the present disclosure.

The terms “first”, “second”, and “third”, etc. are merely used to distinguish elements having similar properties, and do not indicate or imply relative importance or a specific sequence.

The terms “comprise”, “comprising”, or any other variations thereof are intended to cover a non-exclusive inclusion, and also comprises other elements that are not explicitly listed in addition to comprising those elements listed.

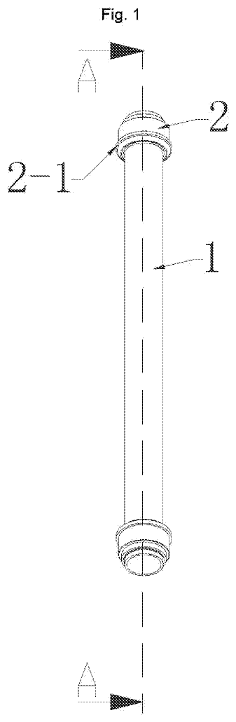

As shown in FIG. 1, embodiments of the present disclosure provide a central tube assembly for a battery. The central tube assembly for the battery includes a central tube 1 and at least one battery center pin 2. The at least one battery center pin 2 is provided on an outer periphery of the central tube 1, each battery center pin 2 is sleeved on the central tube 1 to form the central tube assembly, and the each battery center pin is electrically insulated from the central tube.

Generally, the central tube 1 is a hollow structure, and a coolant is usually introduced into the interior of the hollow structure, for cooling the battery.

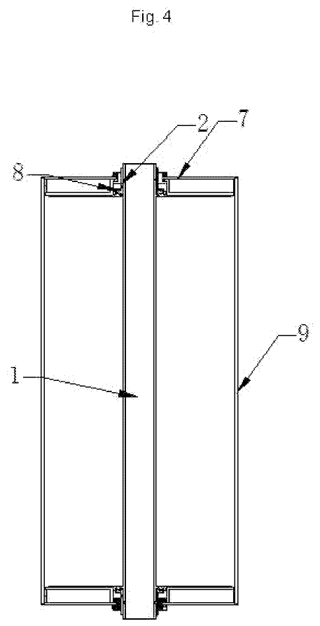

Specifically, as shown in FIGS. 1 and 4, in some embodiments of the present disclosure, the number of the battery center pins 2, as external electrical connection members, is two, and the two battery center pins 2 are generally arranged at two ends of the central tube 1. In some embodiments, the two battery center pins 2 are respectively sleeved at two ends of the central tube 1, wherein the battery center pin at one end is a positive battery center pin, and the battery center pin at the other end is a negative battery center pin. Specifically, the material of the positive battery center pin is a 3-series aluminum alloy, such as 3003, and the material of the negative battery center pin is a copper alloy, such as T2.

In some embodiments, the distance between the upper end face of the battery center pin 2 located above the central tube 1 and the upper end face of the central tube 1 is 1/10 to ⅖ of the length of the central tube 1, and the distance between the lower end face of the battery center pin 2 located below the central tube 1 and the lower end face of the central tube 1 is 1/10 to ⅖ of the length of the central tube 1.

Of course, in some other embodiments, it can only be defined that the distance between the upper end face of the battery center pin 2 located above the central tube 1 and the upper end face of the central tube 1 is 1/10 to ⅖ of the length of the central tube 1, and the distance between the lower end face of the battery center pin 2 located below the central tube 1 and the lower end face of the central tube 1 may be set according to actual situations.

In some other embodiments of the present disclosure, the distance between the upper end face of the battery center pin 2 located above the central tube 1 and the upper end face of the central tube 1 is 5 mm-40 mm, and/or the distance between the lower end face of the battery center pin 2 located below the central tube and the lower end face of the central tube 1 is 5 mm-40 mm.

Of course, positions of the battery center pins 2 can also be adjusted according to actual situations.

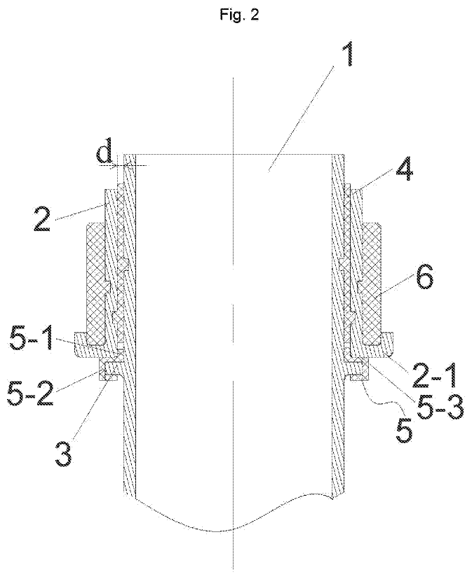

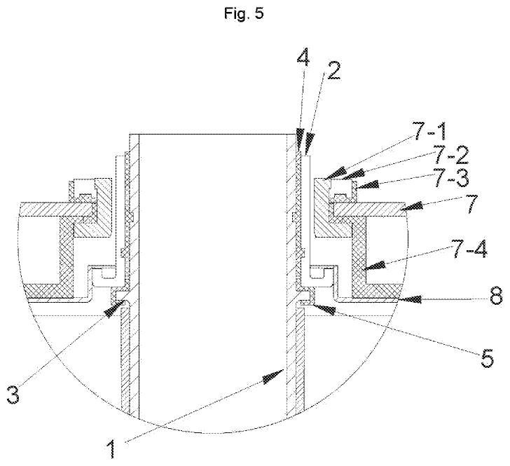

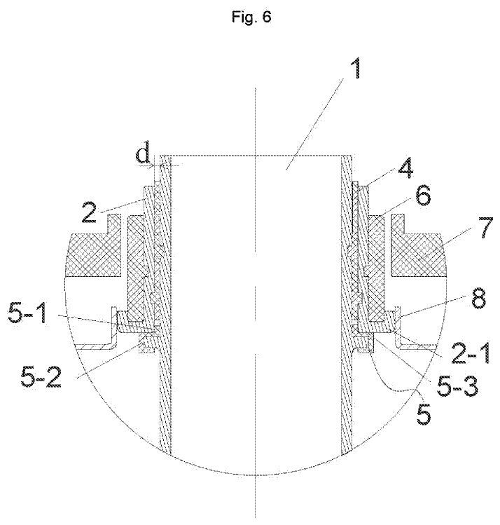

As shown in FIGS. 1 and 2, in some embodiments of the present disclosure, the battery center pins 2 are annular, one end of each battery center pin 2 is provided with an annular flange 2-1, and the annular flange 2-1 is used to be electrically connected with an electrical connection member 8 and the like (for example, a current collector plate). As shown in FIGS. 5 and 6, an outwardly annular flange 2-1 and the electrical connection member 8 are welded and then electrically connected. In some embodiments, the central tube 1 is a metal tube, such as an aluminum central tube, a steel central tube, or a copper central tube.

As shown in FIG. 2, in some embodiments of the present disclosure, the central tube assembly for the battery further includes first insulation members 4, wherein the first insulation members 4 are located between the outer surface of the central tube 1 and the inner surfaces of the battery center pins 2.

By means of the described arrangement, the effects of insulating, fixing and sealing the central tube 1 and the each battery center pin 2 can be achieved by using the first insulation member 4. In some other embodiments, the each first insulation member 4 is made of a polypropylene (PP) material and/or a PPS (Polyphenylene sulfide) material.

Specifically, the annular battery center pins 2 are sleeved on the outer surface of the central tube 1, and at the sleeving positions, the first insulation members 4 are formed between the central tube 1 and the battery center pins 2 by injection molding.

In some embodiments, for convenience of providing the each first insulation member 4, a radial gap d between the inner surfaces of the each battery center pin 2 and the outer surface of the central tube 1 is 0.5 mm-10 mm, in some embodiments, the radial gap d is 2 mm-6 mm, or 1 mm-2 mm. In some other embodiments, as shown in FIG. 5, at each sleeving position, one of the inner surface of the annular battery center pin 2 and the outer surface of the central tube 1 opposite to each other is provided with a protrusion, and the other is provided with a groove; such arrangement increases a contact area, so that the combination of battery center pin and the central tube is firmer.

As shown in FIG. 2, in some embodiments of the present disclosure, since the battery center pin 2 has a certain weight, the central tube assembly for the battery further includes a support member 3 provided on the central tube 1, so that the at least one battery center pin 2 can be supported by the support member 3. In some embodiments, the support member 3 may be a boss structure provided along a radial direction of the central tube 1. In some embodiments, the support member 3 is annular and is sleeved on the central tube 1 at a position close to the corresponding battery center pin 2.

It should be noted that in embodiments of the present disclosure, the support members 3 may be integrally formed with the central tube 1, and may also be welded to the central tube 1.

In some embodiments of the present disclosure, since there are two battery center pins 2, and correspondingly there are also two support members 3; the bottom end of each battery center pin 2 is provided with a support member 3, so that the corresponding battery center pin 2 can be supported and pressed against by the support member 3.

In some embodiments, the support member 3 is annular and has a thickness of 1 mm-20 mm. In some embodiments, the support member 3 has a thickness of 2 mm-15 mm; or 4 mm-10 mm; or 2 mm-4 mm.

In some embodiments of the present disclosure, an insulation coating may also be provided in a middle part of the central tube 1 according to actual situations, for example, the insulation coating may cover the outer surface of the central tube 1 located between the two battery center pins 2. In this way, when the central tube is subsequently assembled to form a battery, an insulation effect between the central tube 1 and rolled electrode sheets is achieved.

The insulation coating is prepared by a nano-injection molding technology (NMT) or an injection molding technology.

As shown in FIG. 2, in some embodiments of the present disclosure, the central tube assembly for the battery further includes a second insulation member 5, wherein the second insulation member 5 is arranged on an outer periphery of the support member 3. In the arrangement above, the second insulation member 5 is used for being insulated from the battery center pin 2.

Specifically, there are two second insulation members 5, each second insulation member 5 is annular and sleeved on the outer surface of the corresponding support member 3.

In some other embodiments, the second insulation member 5 is an electrolyte-resistant insulation material, which specifically may be a polypropylene (PP) material and/or a PPS material.

As shown in FIG. 2, in some other embodiments of the present disclosure, each second insulation member 5 includes a first cylindrical section 5-1 and a second cylindrical section 5-2 connected to each other; an outer diameter of the first cylindrical section 5-1 is smaller than an outer diameter of the second cylindrical section 5-2, the first cylindrical section 5-1 has a first mounting hole, the second cylindrical section 5-2 has a second mounting hole in communication with the first mounting hole, and the corresponding support member 3 is located in the second mounting hole; the first cylindrical section 5-1 is located between the battery center pin 2 and the central tube 1, and a step surface 5-3 capable of supporting the battery center pin 2 is formed between an outer wall surface of the first cylindrical section 5-1 and an outer wall surface of the second cylindrical section 5-2.

In this way, the battery center pin 2 is sleeved on an outer periphery of the first cylindrical section 5-1, and the battery center pin 2 is supported on the step surface 5-3, thereby facilitating mounting of the battery center pin 2. In addition, by using the second insulation member 5, boss serving as the support member 3 can be completely wrapped in an insulation manner, thereby avoiding a problem of short circuit caused by contact between electrode sheet and the boss.

Specifically, as shown in FIG. 2, the second insulation member 5 is formed by stacking an upper annular ring and a lower annular ring, and the middle of the second insulation member is a through hole, and the second insulation member is sleeved on the support member; a whole cross-section of the second insulation member 5 is “convex”-shaped, and the battery center pin 2 can be sleeved on an upper half part of the second insulation member 5.

As shown in FIG. 4 to FIG. 6, some embodiments of the present disclosure further provide a battery. The battery includes a housing 9 and the described central tube assembly for the battery provided in the housing 9.

The battery further includes a cell wound around the outer periphery of the central tube 1 and an electrical connection member 8, wherein one end of the electrical connection member 8 is electrically connected with the battery center pin 2, and the other end of the electrical connection member 8 is electrically connected with a tab of the cell.

Specifically, the battery further includes cover plates 7, wherein the cover plates 7 are provided at both ends of the housing 9. The cover plates 7 may be made of a metal material, and also may not be made of a metal material.

If the cover plates 7 are not made of a metal material, third insulation members 6 need to be provided. In some embodiments, as shown in FIGS. 2 and 6, each third insulation member 6 is provided on the outer surface of the battery center pin 2, the annular flange 2-1 is used to support the third insulation member 6, and the third insulation member 6 is configured to be fixedly connected to the cover plate 7. In some other embodiments, the third insulation member 6 is made of at least one of a PPH (Polyproplyene-Homo) material, a polypropylene PP material or a PPS material.

In some other embodiments, if the cover plate 7 is not made of a metal material, the cover plate 7 and the third insulation member 6 are connected in a sealing manner by hot melting or wire filling (e.g. plastic wires) welding; and when the third insulation member 6 and the cover plate 7 are made of the same material, for example, a PPH material, the third insulation member 6 and the cover plate 7 may be sealed by hot melting. In some embodiments, the cover plate 7 is an annular structure made of PPH, and the cover plate 7 is sleeved on the outer periphery of the third insulation member 6.

As shown in FIG. 5, in some embodiments of the present disclosure, the cover plate 7 is made of a metal material, and if the cover plate 7 is generally made of an aluminum material, then the third insulation member 6 is not needed. In order to ensure welding connection between the cover plate 7 and the battery center pin 2, the battery further includes a first metal connection member 7-1 and a second metal connection member 7-2. The second metal connection member 7-2 is connected with the cover plate 7 in an insulation manner, the second metal connection member 7-2 is snap-fitted to the first metal connection member 7-1, and the first metal connection member 7-1 is insulated from the cover plate 7. In the solutions above, the first metal connection member 7-1 is connected with the battery center pin 2 in a welding manner. Specifically, the second metal connection member 7-2 is electrically insulated from the cover plate 7 by a first cover plate insulation member 7-3, and the cover plate 7 is insulated from the electrical connection member 8 by a second cover plate insulation member 7-4.

It should be noted that in some embodiments of the present disclosure, the battery central tube assembly and the electrical connection member 8 are designed in a concentric circle structure, so that the centers of mass are all at the center, and thus there is no current deviation.

The embodiments of the present disclosure also provide a manufacturing method of a central tube assembly for a battery. The manufacturing method is used for manufacturing the described central tube assembly for the battery. The manufacturing method includes: sleeving at least one battery center pin 2 on the outer surface of a central tube 1 to form the central tube assembly.

In some embodiments of the present disclosure, the manufacturing method further includes:
providing a support member 3 on an outer periphery of the central tube 1; and
sleeving a second insulation member 5 on the outer periphery of the support member 3, and sleeving the battery center pin 2 on a part of the outer periphery of the second insulation member 5.

In some embodiments of the present disclosure, the manufacturing method further includes: reserving a radial distance d of 0.5 mm-10 mm between each battery center pin 2 and the central tube, and performing injection molding processing between the battery center pin 2 and the central tube 1 to form the first insulation member 4.

In the solutions above, the first insulation member 4, the battery center pin 2, and the central tube 1 are formed into an integrated structure by an injection molding manner; in this way, the situation in which the battery center pin 2 and the central tube 1 are separately provided in the related art can be avoided, and a welding process during battery manufacturing is reduced.

In some embodiments of the present disclosure, the manufacturing method further includes: forming a third insulation member 6 on the outer periphery of the battery center pin 2 by injection molding.

Hereinafter, an assembly process of the central tube assembly for the battery and an assembly process of the battery are described:

Specifically, the assembly process of the central tube assembly for the battery is as follows: the support member 3 is provided on the outer periphery of the central tube 1, then the second insulation member 5 is sleeved on the support member 3 outside the central tube 1, and then the annular battery center pin 2 is sleeved on part of the outer side of the second insulation member 5, and is compacted and sealed; and then, injection molding is performed between inner surfaces of the annular battery center pin 2 and the outer surface of the central tube 1 to form the first insulation member 4, and finally, the annular third insulation member 6 is sleeved outside the annular battery center pin 2, and a nano-injection molding technology (NMT) is performed, so that complete the assembly.

Of course, in some other embodiments, when the cover plates 7 are made of a metal material, the third insulation members 6 do not need to be provided, and thus the last process step in the assembly process above does not need to be provided.

In the assembly process of the battery, after the central tube assembly for the battery is assembled according to the described steps, positive and negative electrode sheets and a separator are wound around the central tube 1 to form a bare cell, and then tabs at two ends of the bare cell are respectively welded to the electrical connection members 8, then laser welding is performed on the electrical connection members 8 and the corresponding battery center pins 2 respectively to form a combined body, and then the combined body is nested in a housing 9 of a circular tube shape, finally, the cover plates 7 are respectively sleeved on two ends of the circular tube-shaped housing 9; wherein if the cover plates 7 are made of a metal material, the each cover plate 7 is first welded to the circular tube-shaped housing 9, and then the first metal connection member 7-1 is welded to the central tube assembly. Specifically, the first metal connection member 7-1 is insulated from the cover plate 7, the second metal connection member 7-2 is snap-fitted to the first metal connection member 7-1, and the second metal connection member 7-2 is connected to the cover plate 7 in an insulation manner by a first cover plate insulation member 7-3, and the first metal connection member 7-1 is connected with the battery center pin 2 in a welding manner, and in this case, the assembly is completed. If the cover plates 7 are not made of a metal material, the each cover plate 7 is first hot-melted with the circular tube-shaped housing 9, and then are hot-melted with the central tube assembly.

From the description above, it can be determined that the embodiments of the present disclosure achieve the following technical effects: the battery center pins are sleeved on the outer surface of the central tube, and the battery center pins are integrated on the central tube, thereby overcoming the situation in the related art that the central tube is separated from the battery center pins, reducing a welding process during battery manufacturing, and greatly enhancing the sealing performance of the battery; in addition, the central tube assembly and the electrical connection members are designed in a concentric circle structure, so that the centers of mass are all at the center, it is ensured that the current of a current collector plate of the battery has no current deviation, thereby increasing the cycle life while increasing the safety performance of the battery.

The content above is only some embodiments of the present disclosure and is not intended to limit the present disclosure. For a person skilled in the art, the present disclosure may have various modifications and variations. Any modifications, equivalent replacements, improvements, etc. made within the spirit and principle of the present disclosure shall all fall within the scope of protection of the present disclosure.

What is claimed is:

1. A central tube assembly for a battery, comprising:
a central tube; and
at least one battery center pin, arranged on an outer periphery of the central tube, each battery center pin being sleeved on the central tube to form the central tube assembly, and the each battery center pin being electrically insulated from the central tube.

2. The central tube assembly for the battery according to claim 1, wherein the central tube assembly for the battery further comprises a first insulation member, wherein the first insulation member is located between an outer surface of the central tube and an inner surface of the at least one battery center pin.

3. The central tube assembly for the battery according to claim 2, wherein the first insulation member is formed between the central tube and the at least one battery center pin by injection molding.

4. The central tube assembly for the battery according to claim 1, wherein the central tube assembly for the battery further comprises at least one support member provided on the central tube, wherein each support member is used for supporting a corresponding battery center pin.

5. The central tube assembly for the battery according to claim 4, wherein the central tube assembly for the battery comprises two battery center pins and two support members, and a bottom end of the each battery center pin is provided with the support member.

6. The central tube assembly for the battery according to claim 4, wherein the central tube assembly for the battery further comprises a second insulation member, wherein the second insulation member is arranged on an outer periphery of each support member.

7. The central tube assembly for the battery according to claim 6, wherein the second insulation member is sleeved on the outer periphery of the each support member.

8. The central tube assembly for the battery according to claim 6, wherein the second insulation member comprises a first cylindrical section and a second cylindrical section connected to each other; an outer diameter of the first cylindrical section is smaller than an outer diameter of the second cylindrical section, the first cylindrical section has a first mounting hole, the second cylindrical section has a second mounting hole in communication with the first mounting hole, and the each support member is located in the second mounting hole; the first cylindrical section is located between the battery center pin and the central tube, and a step surface capable of supporting the battery center pin is formed between an outer wall surface of the first cylindrical section and an outer wall surface of the second cylindrical section.

9. The central tube assembly for the battery according to claim 1, wherein an end of the each battery center pin is provided with an annular flange.

10. The central tube assembly for the battery according to claim 9, wherein the central tube assembly for the battery further comprises:
a third insulation member, arranged on an outer periphery of the each battery center pin, wherein the annular flange is used to support the third insulation member, and the third insulation member is configured to be fixedly connected to a cover plate.

11. The central tube assembly for the battery according to claim 1, wherein a distance between an upper end face of an battery center pin located above the central tube and an upper end face of the central tube is 1/10 to ⅖ of a length of the central tube, and/or a distance between a lower end face of an battery center pin located below the central tube and a lower end face of the central tube is 1/10 to 2/15 of a length of the central tube.

12. The central tube assembly for the battery according to claim 1, wherein a distance between an upper end face of an battery center pin located above the central tube and an upper end face of the central tube is 5 mm-40 mm, and/or a distance between a lower end face of an battery center pin located below the central tube and a lower end face of the central tube is 5 mm-40 mm.

13. The central tube assembly for the battery according to claim 2, wherein a radial distance between the at least one battery center pin and the central tube is 0.5 mm-10 mm, and the radial distance is used for providing the first insulation member.

14. A battery, comprising a housing, and the central tube assembly for the battery according to claim 1 provided in the housing.

15. The battery according to claim 14, wherein the battery further comprises a cell wound around the outer periphery of the central tube and an electrical connection member, wherein one end of the electrical connection member is electrically connected with the battery center pin, and the other end of the electrical connection member is electrically connected with a tab of the cell.

16. A manufacturing method for a central tube assembly for a battery, wherein the manufacturing method is used for manufacturing the central tube assembly for the battery according to claim 1, and the manufacturing method comprises:
sleeving the at least one battery center pin on an outer surface of the central tube to form the central tube assembly.

17. The manufacturing method according to claim 16, wherein the manufacturing method further comprises: reserving a radial distance d of 0.5 mm-10 mm between the at least one battery center pin and the central tube, and performing injection molding processing between the at least one battery center pin and the central tube to form at least one first insulation member.

18. The manufacturing method according to claim 16, wherein the manufacturing method further comprises:
providing a support member on the outer periphery of the central tube; and
sleeving a second insulation member on the outer periphery of the support member, and sleeving the each battery center pin on a part of an outer periphery of the second insulation member.

19. The manufacturing method according to claim 18, wherein the manufacturing method further comprises: forming a third insulation member on an outer periphery of the at least one battery center pin by injection molding.
